(19) United States
(12) Patent Application Publication
(10) Pub. No.: US 2020/0079590 A1
(43) Pub. Date: Mar. 12, 2020

(54) FULLY ADJUSTABLE AGGREGATE HOPPER SYSTEM AND METHOD

(71) Applicant: Dan Paugh, Washago (CA)

(72) Inventor: Dan Paugh, Washago (CA)

(21) Appl. No.: 16/542,590

(22) Filed: Aug. 16, 2019

Related U.S. Application Data
(60) Provisional application No. 62/730,451, filed on Sep. 12, 2018.

(51) Int. Cl. B65G 11/20; B65G 11/18

(52) U.S. Cl. CPC B65G 11/206; B65G 11/186

(57) ABSTRACT

A fully adjustable aggregate hopper system, comprising: a hopper box, the hopper box formed from a pair of opposed side panels each having an attached back panel, with the back panels overlapping each other and having a width adjustment mechanism located at each end of the hopper box; and a plurality of legs attached to the hopper box, each leg having a height adjustment mechanism to independently adjust height for each leg.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of conveyors: power-driven of existing art and more specifically relates to a fully adjustable aggregate hopper system.

### RELATED ART

Mining occurs in many areas of the country to garner the materials necessary for producing products for use, distribution and/or sale. In aggregate processing mines a conveyor is run into a hopper. Hoppers are particularly designed to receive and discharge both solid and liquid material by the mounting of a selected valve. Conventional hoppers are typically fabricated on sight to very specific dimensioning. This is often expensive and time-consuming. A suitable solution is desired.

U.S. Pat. No. 6,074,298 to David S. Majkrzak et al., relates to an extended height combine hopper leveling auger. The described extended height combine hopper leveling auger includes a leveling auger for an extendable height combine grain hopper which is mounted onto supports pivoted on brackets so that the auger is effective to level grain in the hopper extension space when in a usable position. The auger will move grain into the regions defined by the hopper extensions. The supports can be pivoted to move the leveling auger to a lowered position. When in its lowered position, the auger is below the level of the hopper after the extension walls are folded down for clearance purposes. A separate grain level sensing switch is used for operating the leveling auger so that the leveling auger is run only when grain has reached a preselected height in the grain hopper.

### SUMMARY OF THE INVENTION

In view of the foregoing disadvantages inherent in the known conveyors: power-driven art, the present disclosure provides a novel fully adjustable aggregate hopper system. The general purpose of the present disclosure, which will be described subsequently in greater detail, is to provide an efficient and effective fully adjustable aggregate hopper system.

The aggregate hopper, as disclosed herein, comprises a fully adjustable aggregate hopper system, comprising: a hopper box, the hopper box formed from a pair of opposed side panels each having an attached back panel, with the back panels overlapping each other and having a width adjustment mechanism located at each end of the hopper box; and a plurality of legs attached to the hopper box, each leg having a height adjustment mechanism to independently adjust height for each leg. The hopper system may also be provided as a kit.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fully adjustable aggregate hopper system, constructed and operative according to the teachings of the present disclosure.

FIG. 1 is a perspective view of the fully adjustable aggregate hopper system during an ‘in-use’ condition, according to an embodiment of the disclosure.

FIG. 2 is a transparent top view of the fully adjustable aggregate hopper system of FIG. 1.

FIG. 3 is a transparent end view of the fully adjustable aggregate hopper system of FIG. 1.

FIG. 4 is a transparent side view of the fully adjustable aggregate hopper system of FIG. 1.

The various embodiments of the present invention will hereinafter be described in conjunction with the appended drawings, wherein like designations denote like elements.

### DETAILED DESCRIPTION

As discussed above, embodiments of the present disclosure relate to conveyors: power-driven and more particularly to a fully adjustable aggregate hopper system as used to improve the efficiency of aggregate processing.

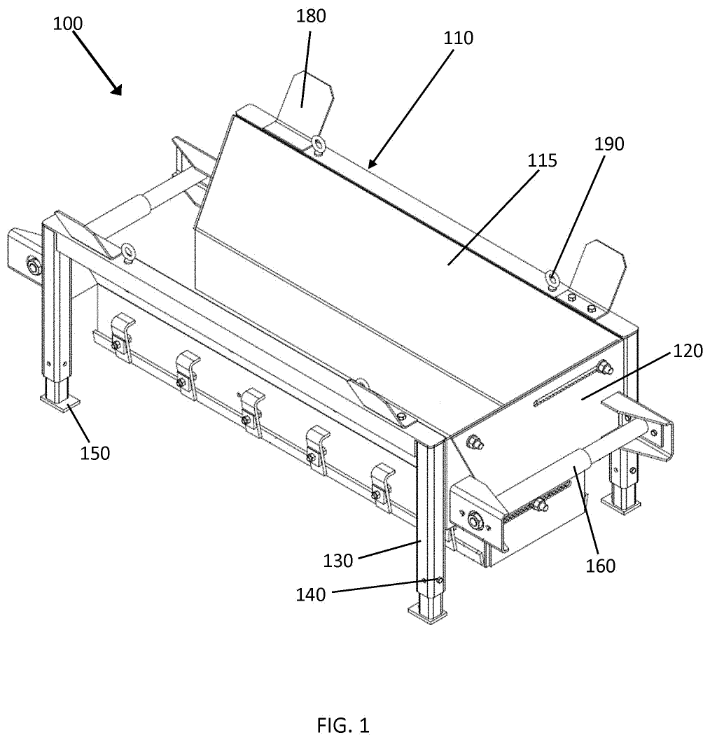

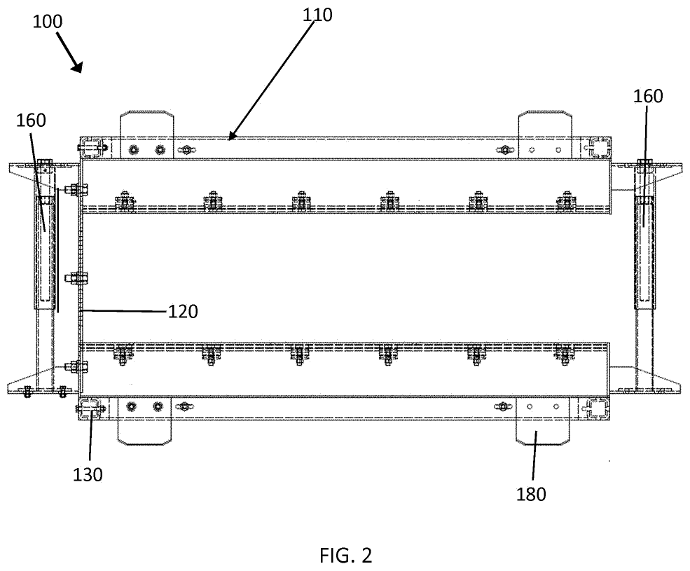

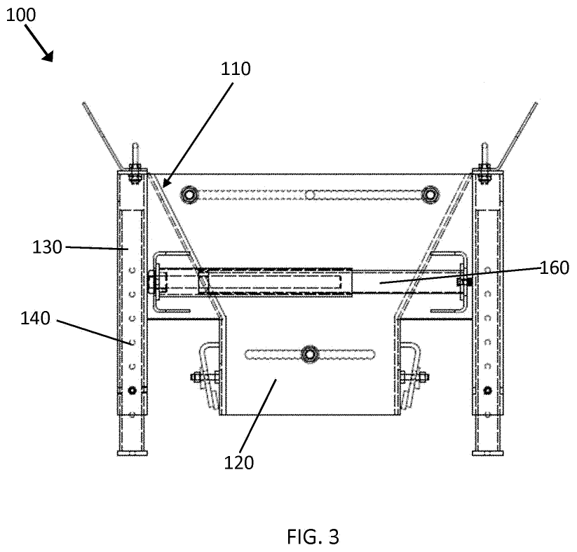

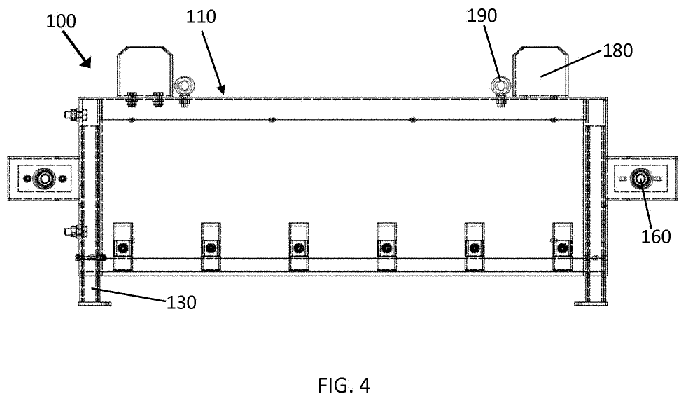

Referring now more specifically to the drawings, there is shown in FIGS. 1-4, various views of a fully adjustable aggregate hopper system. FIGS. 2-4 are shown as transparencies for greater clarity in viewing certain components.

FIGS. 1-4 show a fully adjustable aggregate hopper system 100 in an as-built condition, according to an embodiment of the present disclosure. Here, the fully adjustable aggregate hopper system 100 may be beneficial for use by a user to install and adjust on-sight. As illustrated, and previously mentioned, the fully adjustable aggregate hopper system 100 may include a hopper box 110 formed from two opposed side panels 115 each connected to a back panel 120, with the two back panels 120 overlapping. The hopper width and height is thereby fully adjustable to accommodate different size conveyors that may connect above and below the hopper box 110. The hopper system 110 is particularly designed to receive and discharge both solid and liquid material as required. Additional support elements such as brackets 180 and/or eye bolts 190 may be provided as well.

Note that side panels 115 are shown as angled sides, however, flat sides, with or without a protruding flat or angled ledge, may also be used for hopper box 110.

The present hopper has a plurality of adjustable legs 130, preferably four, with each leg 130 being independently adjustable using a height adjustment mechanism for height up and down adjustment, as shown via the sequential apertures 140 provided that a bolt or the like may be inserted therethrough to secure the legs 140 at the desired height once adjusted. The adjustable legs may further comprise feet 150 to promote stability in use. Alternatively, the height adjustment mechanism may be a continuously adjustable mechanism, such as a jack.

The hopper box 110 can also be adjusted to make it wider or narrower via width adjustment mechanism 160 located at either end. Movement of width adjustment mechanism 160 may also require movement of back plates 120 to the desired width. This allows for better alignment on uneven ground as well as being able to accommodate different conveyor widths without having to entirely fabricate a solution on site. Additionally, each width adjustment mechanism 160 may be adjusted independently, which allows for a degree of non-rectangular adjustment of the hopper system 100. Additionally, a sheet of plastic or similar low-friction material (not shown) may be placed between the back plates 120 to facilitate movement. As shown, each width adjustment mechanism 160 comprise a continuously adjustable jack, however, other types of mechanism, such as a continuously adjustable screw, or fixed width adjustment mechanism, such as the bolts and apertures 140 shown for height adjustment of legs 130.

It is expected that the present hopper system 100 may be installed in less than a half-day which is expected to be more cost-effective and avoid delays in production as compared to individual fabrication of hoppers as is previously known. The hopper system 100 may also be provided as a standard assembly kit that can then be quickly assembled on site to accommodate any width and height desired. A crossbar may be used to separate the walls a desired width. The features of the present invention promote ease of coupling to existing equipment.

According to one embodiment, the fully adjustable aggregate hopper system 100 may be arranged as a kit. In particular, the fully adjustable aggregate hopper system 100 may further include a set of instructions. The instructions may detail functional relationships in relation to the structure of the fully adjustable aggregate hopper system 100 such that the fully adjustable aggregate hopper system 100 can be installed, used, maintained, or the like, in a preferred manner.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A fully adjustable aggregate hopper system, comprising:
a hopper box, the hopper box formed from a pair of opposed side panels each having an attached back panel, with the back panels overlapping each other and having a width adjustment mechanism located at each end of the hopper box; and
a plurality of legs attached to the hopper box, each leg having a height adjustment mechanism to independently adjust height for each leg.

2. The hopper system of claim 1, wherein the width adjustment mechanism comprises a continuously adjustable mechanism.

3. The hopper system of claim 2, wherein the continuously adjustable mechanism comprises a jack.

4. The hopper system of claim 1, wherein the width adjustment mechanism comprises a fixed width adjustment mechanism.

5. The hopper system of claim 1, wherein the plurality of legs are four in number.

6. The hopper system of claim 1, wherein the height adjustment mechanism comprises a fixed height adjustment mechanism.

7. The hopper system of claim 1, wherein the height adjustment mechanism comprises a continuously adjustable mechanism.

8. The hopper system of claim 1, further comprising a sheet of low-friction material placed between the back panels.

9. The hopper system of claim 1, wherein the side panels are angled relative to vertical.

10. A kit for a fully adjustable hopper system, comprising:
a hopper box, the hopper box formed from a pair of opposed side panels each having an attached back panel, with the back panels overlapping each other and having a width adjustment mechanism located at each end of the hopper box; and
a plurality of legs attached to the hopper box, each leg having a height adjustment mechanism to independently adjust height for each leg;

11. The kit of claim 10, wherein the width adjustment mechanism comprises a continuously adjustable mechanism.

12. The kit of claim 11, wherein the continuously adjustable mechanism comprises a jack.

13. The kit of claim 10, wherein the width adjustment mechanism comprises a fixed width adjustment mechanism.

14. The kit of claim 10, wherein the plurality of legs are four in number.

15. The kit of claim 10, wherein the height adjustment mechanism comprises a fixed height adjustment mechanism.

16. The kit of claim 10, wherein the height adjustment mechanism comprises a continuously adjustable mechanism.

17. The kit of claim 10, further comprising a sheet of low-friction material placed between the back panels.

18. The kit of claim 10, wherein the side panels are angled relative to vertical.
